(19) United States
(12) Patent Application Publication
(10) Pub. No.: US 2018/0070048 A1
(43) Pub. Date: Mar. 8, 2018

(54) MANAGEMENT OF MEDIA CONTENT ON A STORAGE MEDIUM

(71) Applicant: International Business Machines Corporation, Armonk, NY (US)

(72) Inventors: Hiroshi Araki, Tokyo (JP); Shinobu Fujihara, Tokyo (JP); Tohru Hasegawa, Tokyo (JP); Takeshi Ishimoto, Tokyo (JP); Hiroshi Itagaki, Tokyo (JP); Hiroyuki Miyoshi, Tokyo (JP); Yutaka Oishi, Tokyo (JP)

(73) Assignee: International Business Machines Corporation, Armonk, NY (US)

(21) Appl. No.: 15/256,652

(22) Filed: Sep. 5, 2016

(51) Int. Cl. H04N 5/782; H04N 7/01; H04N 5/913; G11B 27/032

(52) U.S. Cl. CPC H04N 5/782; H04N 7/0117; H04N 2005/91335; G11B 27/032; H04N 5/913

(57) ABSTRACT

A method for managing media content is disclosed. In one embodiment, the method stores a first data part relating to target media content in a storage medium. The first data part include degraded media content of the target media content. The method further stores a second data part relating to the target media content. The second data part includes complemental data configured to be combined with the first data part to reproduce the target media content. A corresponding apparatus and computer program product are also disclosed.

### BACKGROUND

The present invention generally relates to media content storage technology, and more particularly to management of media content using a storage medium.

In response to ever-increasing demand for visual resolution (e.g. 4K, 8K, etc.) in television broadcasting, the data size of video materials used for creating television programs, television advertisements, etc. becomes larger and larger. For example, ultra-high-definition materials with 8K resolution may occupy storage capacity more than a hundred times as large as high-definition materials.

With the advent of LTFS (Linear Tape File System) and it associated capacity and cost-effectiveness, tape media is once again a promising storage media for storing video materials and for interchanging video materials from one process to another in a workflow, which may include production processes and post-production processes. Since transferring video materials through a network may require considerable time and costs due to the video's size, use of tape media may enable transmission of large amounts of data more economically and quickly than network transmissions.

Since video materials are often valuable information assets, the materials need to be protected when shared among participants. Data encryption techniques may be utilized to secure the materials. For example, a content holder may deliver a tape medium storing encrypted materials and pass keys for limited materials that are under agreement. In such cases, a recipient may access the limited materials for which the keys are provided. On the other hand, the recipient may not access or have knowledge of contents for which keys are not provided.

In view of the foregoing, improved techniques are needed for handling media content such as video using a storage medium such as tape.

### SUMMARY

In a first embodiment of the invention, a method is provided for managing media content. The method includes storing a first data part relating to target media content in a storage medium, in which the first data part is a degraded media content of the target media content. The method also includes storing a second data part relating to the target media content, in which the second data part is complemental data configured to be combined with the first data part so as to reproduce the target media content.

In a second embodiment of the invention, a method is provided for managing media content. The method includes reading a first data part relating to target media content from a storage medium, in which the first data part is a degraded media content of the target media content. The method also includes reading a second data part relating to the target media content, in which the second data part is complemental data for complementing the first data part. The method further includes combining the second data part with the first data part so as to reproduce the target media content.

Processing devices and computer program products relating to one or more aspects of the present invention are also described and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 illustrates a flow of media content along with a typical media workflow for making multimedia content;

FIG. 2 is a block diagram of a media content processing device according to an embodiment of the invention;

FIG. 3 describes interchanging of media content between source and destination devices according to an embodiment of the invention;

FIG. 4 is a flowchart depicting a process for storing target media content in storage media in a divided manner according to an embodiment of the invention;

FIG. 5 is a flowchart depicting a process for reading target media content from storage media that stores the target media content in a divided manner according to an embodiment of the invention;

FIGS. 6A and 6B are schematics showing conversion between original media content and divided media content by the media content processing device according to one or more embodiments of the invention;

FIG. 7 is a flowchart depicting a process for dividing original data of the target media content into two data parts by extracting part of frames according to an embodiment of the invention;

FIG. 8 is a flowchart depicting a process for combining two data parts into original data of the target media content by merging frames according to an embodiment of the invention;

FIG. 9 is a flowchart depicting a process for dividing original data of the target media content into two data parts by cutting a partial image according to an embodiment of the invention;

FIG. 10 is a flowchart depicting a process for combining two data parts into original data of the target media content by synthesizing images according to an embodiment of the invention;

FIG. 11 is a schematic showing sharing of media content between multiple participants according to one or more embodiments of the invention;

FIGS. 12A and 12B show sharing of media content between multiple participants according to one or more embodiments of the present invention; and

FIG. 13 is a schematic of a processing device according to one or more embodiments of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

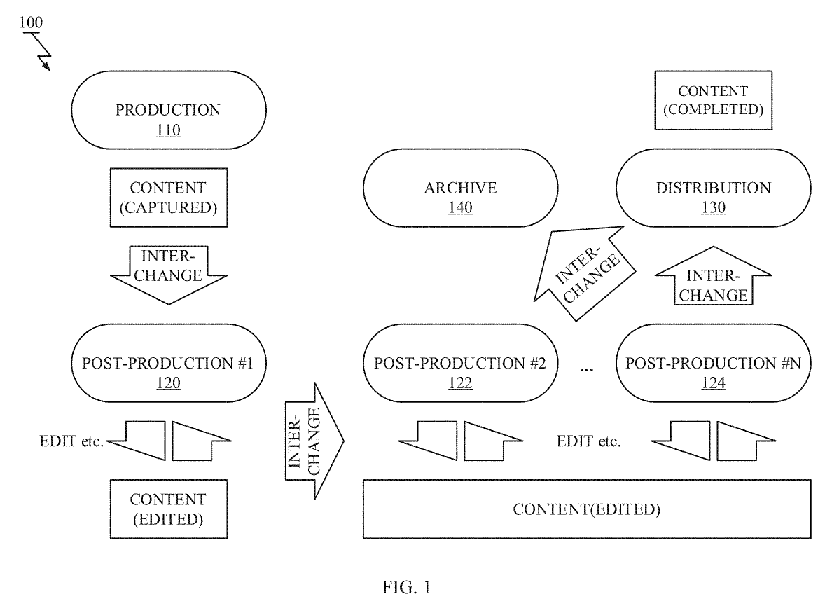

FIG. 1 illustrates a flow of media content along with a typical media workflow for making multimedia content such as television programs, television advertisements, and other audio/visual works.

In the media workflow, video material (media content) captured by a camera and its derivative media content may be moved among multiple participants including television broadcasters, post-production companies, studios, etc.

Video materials captured by the camera at a production site 110 may be delivered to post-production sites 120-124 and subjected to post-production processes. The post-production processes may include a variety of processes including video editing, effect adding, and color correction to name a few, which may involve multiple companies and/or departments working on the video materials. Thus, interchange of materials may occur among post production sites 120-124. The media content processed at a post-production site 120-124 may also be delivered to a distribution site 130 and an archive site 140.

As the size of media content to be interchanged among participants becomes larger and larger, a storage medium such as tape may be used as an interchange medium for carrying media content in the workflow instead of using network transmission.

Media content created through the media workflow may need to be protected when interchanging the content since such media content may be valuable information assets. However, all files stored on the tape medium may be generally accessible since there is no access control technique for controlling access to data on the tape medium.

Data encryption techniques may be utilized to secure video content. A content holder can deliver a tape medium that stores encrypted materials and pass keys for limited materials for which an agreement has been established. In such cases, a recipient may access only those materials for which keys are provided. On the other hand, a recipient may not know of and/or receive access to other encrypted materials for which keys are not made available from the content holder.

Hence, even if a recipient, who may be an editor, wants to have other relevant material during an editing process, the recipient may not be able to identify a corresponding file of the relevant material for which a key is necessary since knowledge of the contents of other media materials may be prevented.

For example, in the case of television advertisements, a large number of different video materials for the same object, which may include materials for different angles associated with the object and materials for different light sources illuminating the object, may be stored in a storage medium. In such a case, a material captured with a different angle, a material captured with different a orientation or shadow, or a material captured with a different object that has a different color other than the limited material would have access thereto prevented.

It is quite useful to permit access to materials other than the limited materials for which an agreement is established. However, even though there is such a demand, the value of the materials useable to create ultra-high-definition television programs may be protected so as not to be diverted to other television programs without an agreement.

There is a need for a method, associated processing device, and computer program product for managing media content using a storage medium, that is capable of permitting access to media content while preventing the media content from being diverted to other purposes outside the scope of an agreement.

Therefore, in one or more embodiments of the present invention, there is provided a novel content management functionality and/or process for managing media content in a divided manner where a degraded media content of target media content and complemental data configured to be combined with the degraded media content are stored as separate data parts of the target media content in different storage media.

Now, referring to FIGS. 1-13, a processing device and method will be described for managing media content using a storage medium according to one or more exemplary embodiments of the present invention.

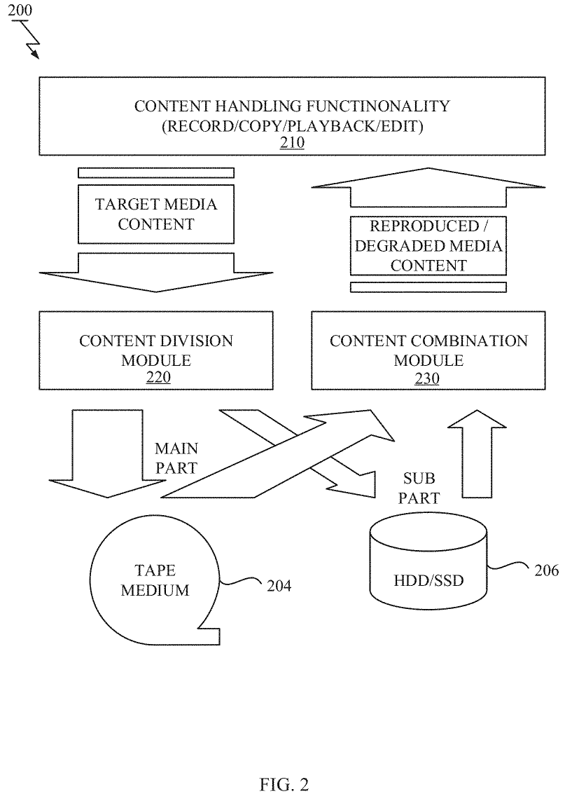

Referring to FIG. 2, a block diagram of a media content processing device 200 is shown according to an exemplary embodiment of the present invention. The media content processing device 200 shown in FIG. 2 may be any kind of processing device that can handle media content such as video materials and audio materials, and store the media content on storage media.

In a particular embodiment, the media content processing device 200 may be a non-linear video editing system that operates video editing software. In another particular embodiment, the media content processing device 200 may be a video camera device such as a television camera that records video content.

As shown in FIG. 2, the media content processing device 200 may include content handling functionality 210, a content division module 220, and a content combination module 230. In FIG. 2, a tape medium 204 and a hard disk drive/solid state drive (HDD/SSD) 206 are also shown as storage media for providing resources to store the media content in a divided manner.

The content handling functionality 210 may represent any kind of content handling functionality including recording, copying, playing back, editing, etc., which involves storing and/or reading media content on storage media. In certain embodiments, the media content handled by the content handling functionality 210 may be uncompressed production-quality video content, for simplicity. However, in other embodiments, the media content may be any kind of media content, which may include compressed video content, uncompressed or compressed images, audio, and/or multimedia content.

The content division module 220 may be configured to divide target media content into a first data part and a second data part to store the first data part and the second data part onto the tape medium 204 and the HDD/SSD 206, respectively. Hereinafter, the first data part to be stored on the tape medium 204 and the second data part to be stored on the HDD/SSD 206 are referred to as “main part” and “sub part”, respectively. The content combination module 230 may be configured to combine the main part and sub part on the tape medium 204 and the HDD/SSD 206 to reproduce the target media content.

The content handling functionality 210 may request that the content division module 220 store designated target media content, which has already been stored on other storage media or is being captured from a source such as a camera, recorder, and/or video editing system.

In the illustrated embodiment, the content division module 220 may be configured to receive original data of the target media content from the content handling functionality 210 and generate the main and sub parts by dividing the original data of the target media content. The main part may be generated by discarding partial information from the original data of the target media content. The sub part may be generated by organizing partial information included in the original data of the target media content, which may include information discarded from the main part. While generating the main and sub parts, the content division module 220 may be configured to store the generated main part on the tape medium 204 and store the generated sub part on the HDD/SSD 206 through file system interfaces.

With respect to generated data parts by the content division module 220, the main part may be degraded media content associated with the target media content, which may in certain embodiments be played back using ordinary video playback functionality in the same way as the original data of the target media content. The main part may be degraded in terms of losing partial information compared to the original data of the target media content. An amount of information in the main part may be lower than an amount of information in the original data of the target media content.

The partial information removed from the main part may be any kind of content building elements or information, which may include some frames in an original series of frames, select images in an original frame, select pixels in an original frame, select color information, select spatial domain information, select frequency domain information, select inter-frame difference information, and/or the like. The information removed from the main part may be or may not be equivalent to the information included in the sub part.

For example, some frames may be discarded from an original series of frames in target media content at predetermined intervals to generate the main part, and the frames discarded from the main part may be included in the sub part. For example, a block partial image in each frame may be discarded from each original frame in the target media content to generate the main part, and the block partial image discarded from the original frame of the main part may be included in the sub part.

In another example, some frames in an original series of frames may be replaced by degraded frames, which may be down-converted frames or watermarked frames, to generate the main part, and the original frames that have been removed may be included in the sub part.

Compared with the original data of the target media content, the main part has lost some information included in the original target media content but can be used to play back the target media content with reduced quality. Note that since division of the target media content may not be intended to reduce the size of the data, the main part may in certain embodiments have a size larger than the original data.

In contrast, the sub part may be complemental data that is configured to be combined with the main part to reproduce the target media content with complete quality. By combining the main part with the sub part, the amount of information would likely be substantially equivalent to that of the original data of the target media content. The size of the sub part may in certain embodiments be smaller than the size of the main part. The greater part of the target media content may be included in the main part and the residual part may be included in the sub part so that copying the sub part to the HDD/SSD 206 does not utilize substantial time or incur substantial cost.

The content handling functionality 210 may request that the content combination module 230 read target media content that has been stored on the tape medium 204 and the HDD/SSD 206 in a divided manner.

In the illustrated embodiment, the content combination module 230 may be configured to read the main and sub parts relating to the target media content from the tape media 204 and the HDD/SSD 206 through file system interfaces. While reading the main and sub parts, the content division module 220 may be configured to combine the sub part with the main part to reproduce the target media content and transmit the reproduced target media content to the content handling functionality 210. The reproduced target media content may have a quality that is greater than the main part. In a preferred embodiment, the target media content can be reproduced with complete quality by combining the main and sub parts.

The content handling functionality 210 may play back the reproduced target media content preferably with complete quality. In one embodiment, the reproduced target media content may be stored on another medium prior to play back. In an alternative embodiment, the reproduced target media content may be reproduced by the content combination module 230 at the time of playback. Similarly, the content handling functionality 210 may edit, transform, or copy the reproduced target media content, preferably with complete quality.

If there is no sub part corresponding to the target media content, the content division module 220 may transmit the main part to the content handling functionality 210 while reading merely the main part. In such a case, the content handling functionality 210 may play back the target media content based on the main part, which is a degraded version of the target media content.

Even if the sub part relating to the target media content is not available, the content handling functionality 210 may play back the target media content with quality that is lower than the reproduced target media content.

In a particular embodiment, the content division module 220 and content combination module 230 may be incorporated into file system functionality, which manages an association between a main part on the tape medium 204 and a sub part on the HDD/SSD 206 by using file trees for example, and convert between original media content (in the form of original data) and divided media content (in the form of the main and sub parts) transparently to external modules (e.g., applications). In this particular embodiment, the media content may be handled by the external modules as a single file but the main and sub parts of the media content may be managed internally and a user can designate target media content by its file name.

In another embodiment, the content division module 220 and the content combination module 230 may be implemented as an application or a component of video editing software, video player, or video recorder, which converts between the original media content and the divided media content. In this embodiment, the main and sub parts of the media content may be handled as multiple files and a user can designate target media content by a file name of the main part or file names of the main and sub parts.

Each of the modules 210, 220, 230 described in FIG. 2 may be, but are not limited to, implementation as software modules including program instructions and/or data structures in conjunction with hardware components such as a processor, memory, etc.; as hardware modules including electronic circuitry; or as combinations thereof. The modules 210, 220, 230 described in FIG. 2 may be implemented on a single computing device such as a personal computer, workstation, server machine, video camera, video recorder, or the like, or over a plurality of devices such as a cluster of the computing devices in a distributed manner.

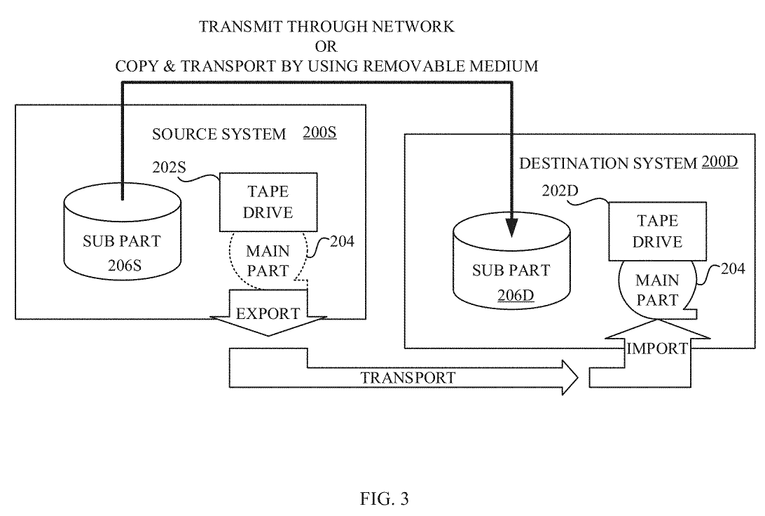

Referring to FIG. 3, interchanging of media content between source and destination devices 200S, 200D is illustrated. At a source device 200S, target media content may be stored as a set of one or more main parts on the tape medium 204 and a set of one or more sub parts on the HDD/SSD drive 206S. In order to interchange the media content, the source device 200S that is equipped with a tape drive 202S may export the tape medium 204 that stores the set of one or more main parts. The tape medium 204 exported from the source device 200S may be transported to a site hosting destination device 200D and inserted into a tape drive 202D of the destination device 200D.

At this time, all the media content stored on the tape medium 204 may be played back with incomplete quality using the main parts stored on the tape medium 204. The recipient can browse the media content stored on the tape medium 204 using the main parts.

The source device 200S may output a subset of the one or more sub parts on the HDD/SSD drive 202S. In one embodiment, the subset of the sub parts may be copied into a removable medium such as a flash memory device. The removable medium may be transported to the site of the destination device 200D and mounted to the destination device 200D. In other embodiments, the subset of the sub parts may be transferred to the destination device 200D over a network. Since the size of the sub parts may be smaller than the main parts as well as the original data of the target media content, transferring the sub parts over a network may not unacceptably increase time and/or cost.

In this manner, the sub part of media content to be shared may be copied into the removable medium or transferred through the network at the time of sharing the media content, and can be shared along with the tape medium 204 on which the main part is stored.

At this time, media content that utilizes the main and sub parts can be played back with complete quality using the main parts stored on the tape medium 204 and the sub parts stored on the removable medium or the HDD/SSD 206D to which the sub parts may be moved from the removable medium or transmitted from the source device 200S.

Media content that does not include the sub part may be played back using the main part but with incomplete quality. Since the main part contains degraded media content, the recipient cannot divert the media content or use it in an unauthorized manner.

The source-destination relationship shown in FIG. 3 may be implemented in any two of the sites shown in FIG. 1. The tape medium may be transferred from one site to another in the workflow that may include, but not limited to, the production site 110, the post-production sites 120-122, the distribution site 130, and/or the archive site 140.

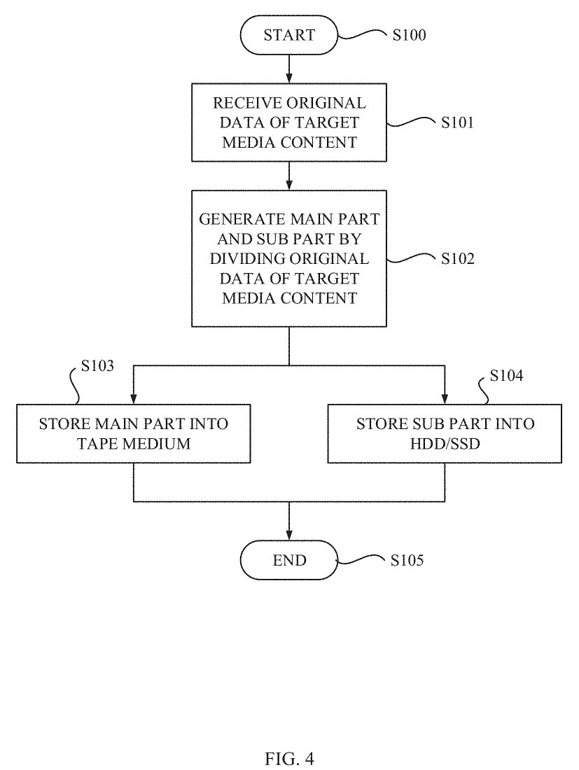

Referring to FIG. 4, a flowchart is shown depicting a process for storing target media content in storage media in a divided manner. Note that the process shown in FIG. 4 may be performed by a processing unit that implements the functionality of the content division module 220 shown in FIG. 2.

The process shown in FIG. 4 may begin at step S100 by receiving a request to store target media content with an argument that specifies the target media content to be stored. A user can designate the target media content by a file name of existing media content or as an instruction for recording new video via user interface that may be provided by the content handling functionality 210.

At step S101, the content division module 220 receives the original data of the target media content from the content handling functionality 210. At step S102, the content division module 220 generates the main and sub parts by dividing the original data of the target media content. The main part may be generated by discarding some information from the original data of the target media content. The sub part may be generated by organizing the information that was discarded from the original data of the target media content.

At step S103, the content division module 220 stores the generated main part relating to the target media content on the tape medium 204. At step S104, the content division module 220 stores the generated sub part relating to the target media content on the HDD/SSD 206. At step S105, the process ends.

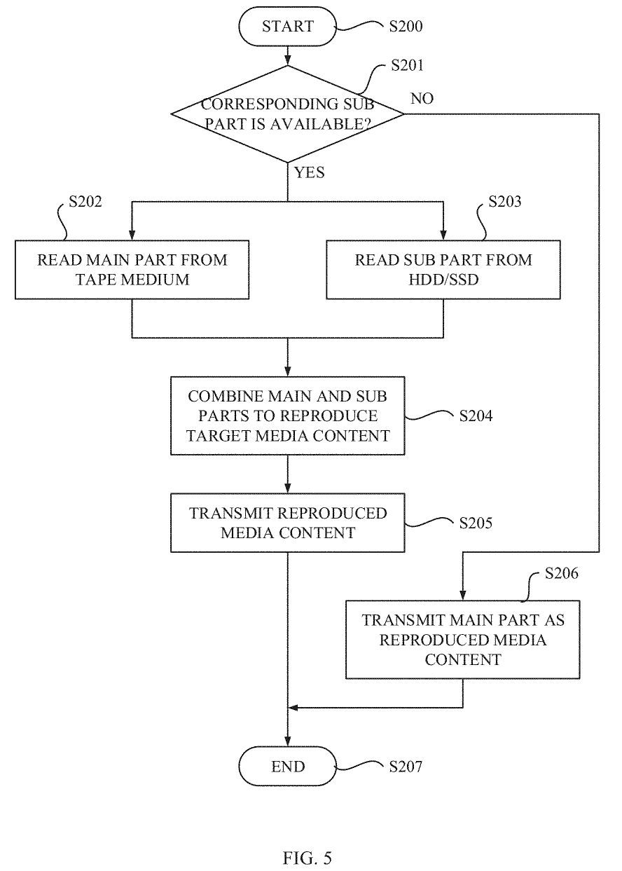

Referring to FIG. 5 a flowchart is shown depicting a process for reading target media content from storage media that stores the target media content in a divided manner. Note that the process shown in FIG. 5 may be performed by a processing unit that implements the functionality of the content combination module 230 shown in FIG. 2.

The process shown in FIG. 5 may begin at step S200 by receiving a request to read target media content with an argument that specifies the target media content to be read. A user may designate the target media content by file name of the main and/or sub parts via user interface provided by the content handling functionality 210.

At step S201, the content combination module 230 determines whether a sub part corresponding to the main part is available or not. If the content combination module 230 determines that the corresponding sub part is available at step S201, the process may proceed to steps S202 and S203.

At step S202, the content combination module 230 reads the main part relating to the target media content from the tape medium 204. At step S203, the content combination module 230 reads the sub part relating to the target media content from the HDD/SSD 206.

At step S204, the content combination module 230 combines the main and sub parts to reproduce the target media content. At step S205, the content combination module 230 transmits the reproduced media content to the content handling functionality 210 and the process ends at step S207.

If the content combination module 230 determines that the corresponding sub part is not available at step S201, the process branches to step S206. At step S206, the content combination module 230 reads the main part relating to the target media content from the tape medium 204 and transmits the main part to the content handling functionality 210 as the reproduced media content of the target media content and the process ends at step S207.

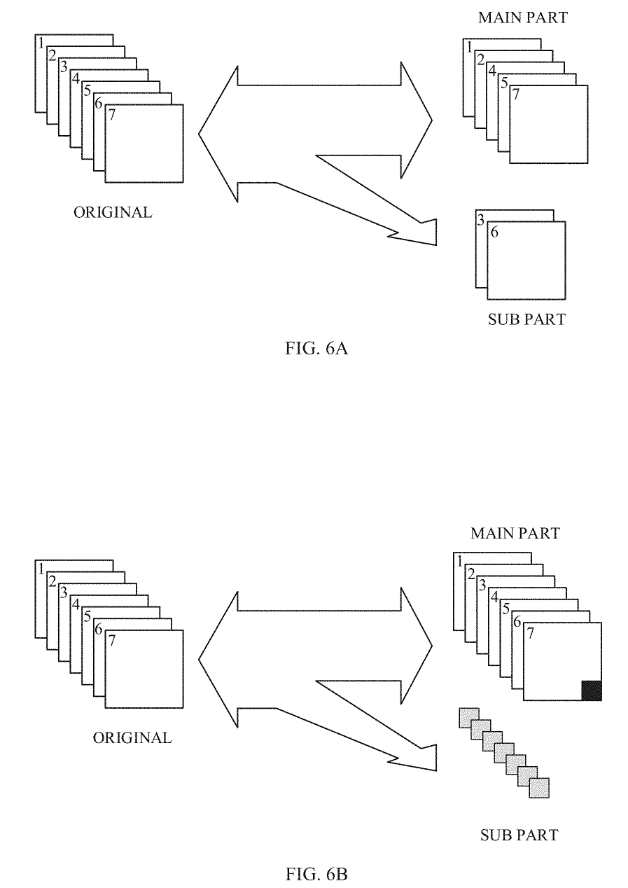

Referring to FIGS. 6A, 7 and 8, a process for converting between original media content and divided media content is described in detail, where some frames may be extracted/merged, according to a particular embodiment of the present invention.

FIG. 6A depicts a schematic for converting between original media content and divided media content according to the particular embodiment.

As shown in this embodiment, to convert from original media content to divided media content, some frames (e.g., 1, 2, 4, 5, 7) may be extracted from an original series of frames in target media content to generate a main part. The remaining frames (e.g., 3,6) may be stored in a sub part. To convert from the divided media content to the original media content, the main part including frames (e.g., 1, 2, 4, 5, 7) may be merged into the sub part including frames (e.g., 3,6) to recover the original series of frames (e.g., 1, 2, 3, 4, 5, 6, 7) in the target media content.

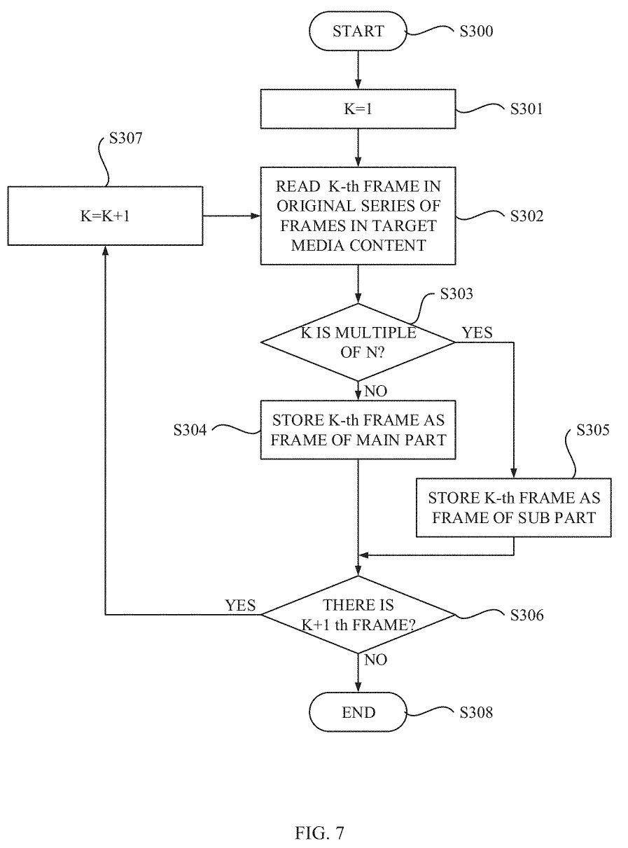

FIG. 7 is a flowchart depicting a process for dividing original data of target media content into two data parts by extracting some frames from an original series of frames in the target media content. Note that the process shown in FIG. 7 may be performed by a processing unit that implements the functionality of the content division module 220 shown in FIG. 2.

The process shown in FIG. 7 begins at step S300 in response to receiving a request for storing target media content. At step S301, the content division module 220 initializes variable K. At step 302, the content division module 220 reads the K-th frame in an original series of frames in the received target media content. Note that the content division module 220 may be configured to recognize frames in the target media content received from the content handling functionality 210.

At step S303, the content division module 220 determines whether the variable K is a multiple of N (N denotes an interval for extraction) or not. If the content division module 220 determines that the variable K is not a multiple of N at step S303, the process may proceed to step S304. If the variable K is not divisible by N, the process may proceed to step S304. At step S304, the content division module 220 may store the K-th frame as a frame of the main part on the tape medium 204.

If the content division module 220 determines that the variable K is a multiple of N at step S303, the process branches to step S305. Stated otherwise, if the variable K is divisible by N, the process branches to step S305. At step S305, the content division module 220 stores the K-th frame as a frame of the sub part on the HDD/SSD 206.

At step S306, the content division module 220 determines whether there is a (K+1)-th frame or not. If the content division module 220 determines that there is a (K+1)-th frame at step S306, the process proceeds to step S307 to increment the variable K and loop back to step S302. If the content division module 220 determines that there is not a (K+1)-th frame at step S306, the process ends at step S308.

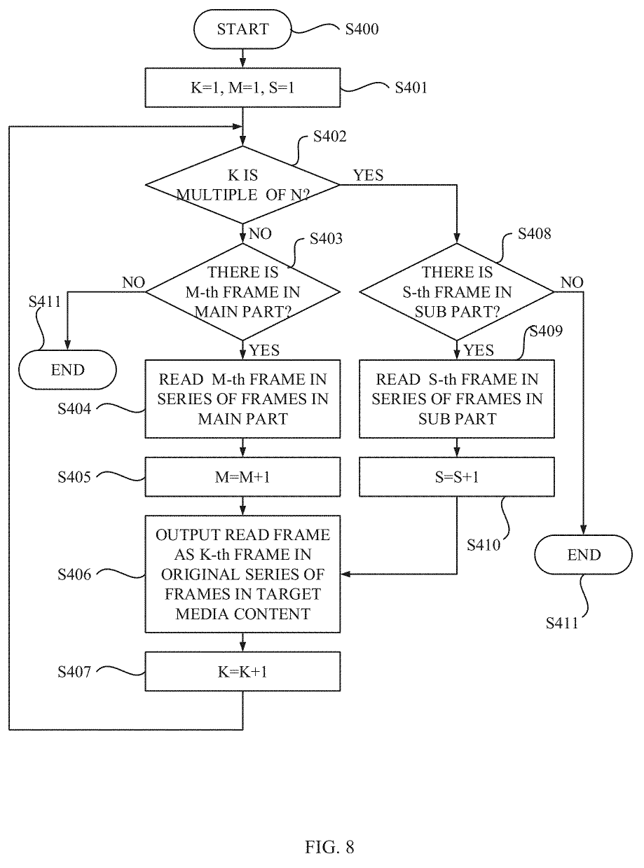

FIG. 8 is a flowchart depicting a process for combining two data parts into original data of the target media content by merging frames of the two data parts relating to the target media content. Note that the process shown in FIG. 8 may be performed by a processing unit that implements the functionality of the content combination module 230 shown in FIG. 2.

The process shown in FIG. 8 may begin at step S400 in response to receiving a request for reading target media content. At step S401, the content combination module 230 initializes variables K, M, and S.

At step S402, the content combination module 230 determines whether the variable K is a multiple of N or not. If the content combination module 230 determines that the variable K is not a multiple of N at step S402, the process proceeds to step S403. At step S403, the content combination module 230 determines whether there is an M-th frame in the main part or not.

If the content combination module 230 determines that there is an M-th frame at step S403, the process proceeds to step S404. At step 404, the content combination module 230 reads the M-th frame in a series of frames in the main part on the tape medium 204. Note that the content combination module 230 may be configured to recognize frames in the data parts read from the storage media. At step 405, the content combination module 230 increments the variable M and proceeds to step S406.

If the content combination module 230 determines that the variable K is a multiple of N at step S402, the process proceeds to step S408. At step S408, the content combination module 230 determines whether there is an S-th frame in the sub part or not. If the content combination module 230 determines that there is an S-th frame at step S408, the process proceeds to step S409. At step 409, the content combination module 230 reads the S-th frame in a series of frames in the sub part on the HDD/SSD 206. At step 410, the content combination module 230 increments the variable S and proceeds to step S406.

At step 406, the content combination module 230 outputs read frame (M-th frame in the main part/S-th frame in the sub part) as a K-th frame in the original series of frames in the target media content. At step 407, the content combination module 230 increments the variable K and loops back to step S402.

If the content combination module 230 determines that there is not an M-th frame at step S403, the process ends at step S411. If the content combination module 230 determines that there is not an S-th frame at step S408, the process ends at step S411.

Referring to FIGS. 6B, 9, and 10, a process for converting between original media content and divided media content will be described in detail, where a partial image in a frame may be cut/synthesized according to an embodiment of the present invention.

FIG. 6B is a schematic showing conversion between original media content and divided media content in accordance with the embodiment.

In this embodiment, to convert from the original media content to the divided media content, a block partial image may be cut from each original frame in the target media content to generate a main part that includes a partially black-filled remaining image of each frame. The block partial image of each frame may be stored in the sub part. To convert from the divided media content to the original media content, the partially black-filled image in the main part may be synthesized with the corresponding partial image in the sub part to recover the whole image of each original frame in the target media content.

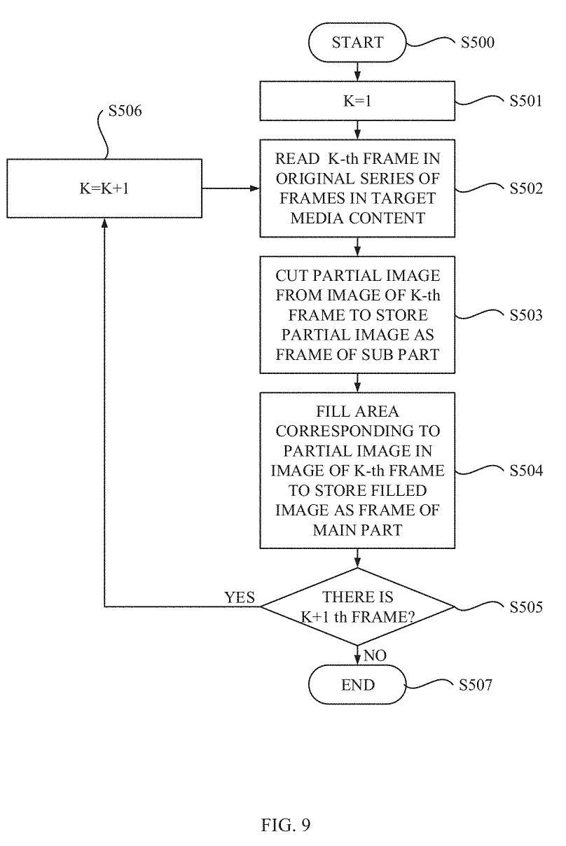

FIG. 9 is a flowchart depicting a process for dividing original data of target media content into two data parts by cutting a partial image from each original frame in the target media content. Note that the process shown in FIG. 9 may be performed by a processing unit that implements the functionality of the content division module 220 shown in FIG. 2.

The process shown in FIG. 9 may begin at step S500 in response to receiving a request for storing target media content. At step S501, the content division module 220 initializes variable K. At step 502, the content division module 220 reads the K-th frame in an original series of frames in received target media content.

At step S503, the content division module 220 cuts a partial image having a predetermined size (e.g., W×H) at a predetermined position (e.g., right bottom) from an original image of the K-th frame and stores the partial image as a frame of a sub part on the HDD/SSD 206. At step S504, the content division module 220 fills with black an area corresponding to the partial image in the original image of the K-th frame to store the partially black-filled image as a frame of a main part on the tape medium 204.

At step S505, the content division module 220 determines whether there is a (K+1)-th frame or not. If the content division module 220 determines that there is a (K+1)-th frame at step S505, the process proceeds to step S506 to increment the variable K and loop back to step S502. If the content division module 220 determines that there is not a (K+1)-th frame at step S505, the process ends at step S507.

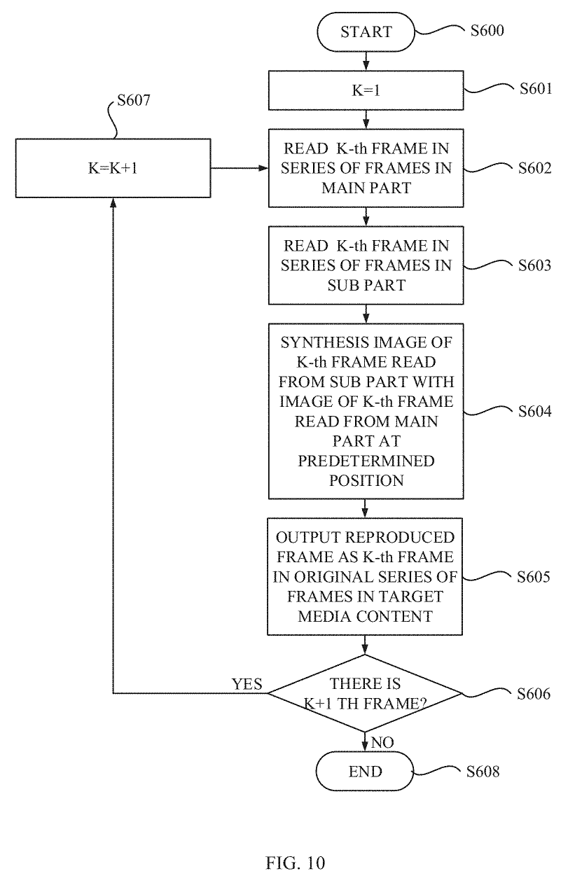

FIG. 10 is a flowchart depicting a process for combining two data parts into original data of target media content by synthesizing images of the two data parts relating to the target media content. Note that the process shown in FIG. 10 may be performed by a processing unit that implements the functionality of the content combination module 230 shown in FIG. 2.

The process shown in FIG. 10 may begin at step S600 in response to receiving a request to read target media content. At step S601, the content combination module 230 initializes variable K. At step 602, the content combination module 230 reads the K-th frame in a series of frames in the main part on the tape medium 204. At step 603, the content combination module 230 reads the K-th frame in a series of frames in the sub part on the HDD/SSD 206.

At step S604, the content combination module 230 synthesizes an image of the K-th frame read from the sub part with an image of the K-th frame read from the main part at the predetermined position.

At step 605, the content combination module 230 outputs a synthesized frame as the K-th frame in the original series of the target media content. At step S606, the content combination module 230 determines whether there is a (K+1)-th frame or not. If the content combination module 230 determines that there is a (K+1)-th frame at step S606, the process proceeds to step S607 to increment the variable K and loop back to step S602. If the content combination module 230 determines that there is not a (K+1)-th frame at step S606, the process ends at step S608.

In FIGS. 6-10, various embodiments of methods for converting between original and divided media content have been described. However, methods for converting between the original and divided media content are not limited to the specific embodiments shown in FIGS. 6-10.

Conversion techniques may be deemed to fall within the scope of the invention if the main and sub parts satisfy the following conditions: (1) the main part may be used on its own to play back target media content with incomplete quality; (2) an amount of information in the main part may be lower than that of original data of the target media content; and (3) by combining the main part with the sub part, the amount of information may increase preferably to an amount equivalent to the original data of the target media content.

In other embodiments, the target media content may be divided into a main part and two or more sub parts instead of one sub part. In such embodiments, the main part may be used on its own to play back the target media content with incomplete quality and the main part and the two or more sub parts may be combined to reproduce the target media content with complete quality.

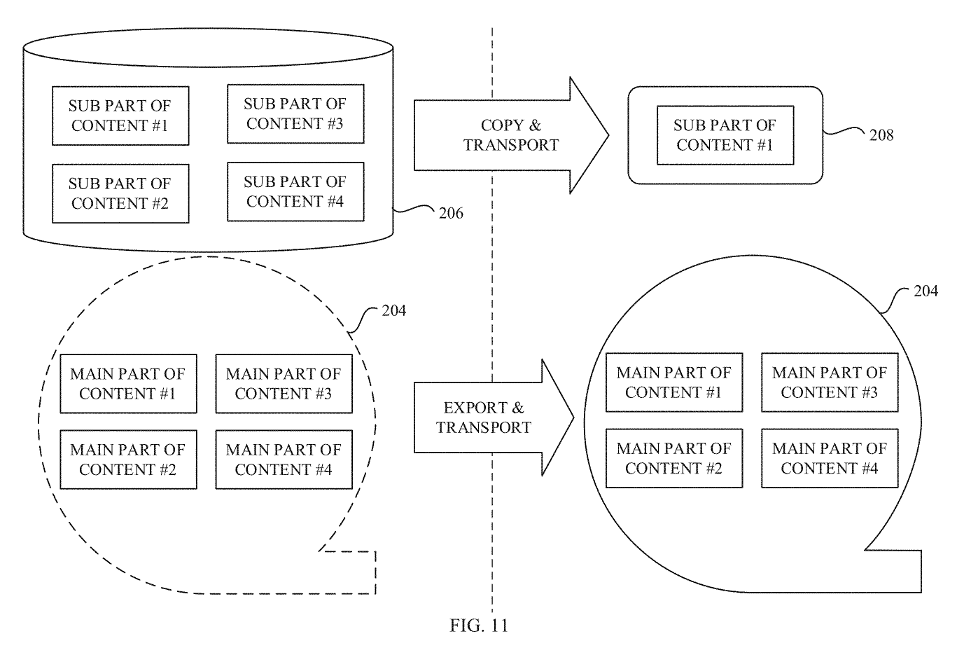

Referring to FIG. 11, a schematic is shown for sharing media content between multiple participants, which may include a content holding company and a post-production company by way of example. As shown in FIG. 11, the content holding company may store media content in a storage system where the tape media 204 and other storage media such as HDD/SSD 206 are combined. The main parts of the media content (i.e., content #1-#4) may be stored on the tape media 204. The sub parts of the media content (i.e., content #1-#4) may be stored on the HDD/SSD 206.

When interchanging certain media content (e.g., content #1), the content holding company may copy the sub part of the media content onto a removable storage medium 208 and transport the removable medium 208 to the post-production company along with the tape medium 204.

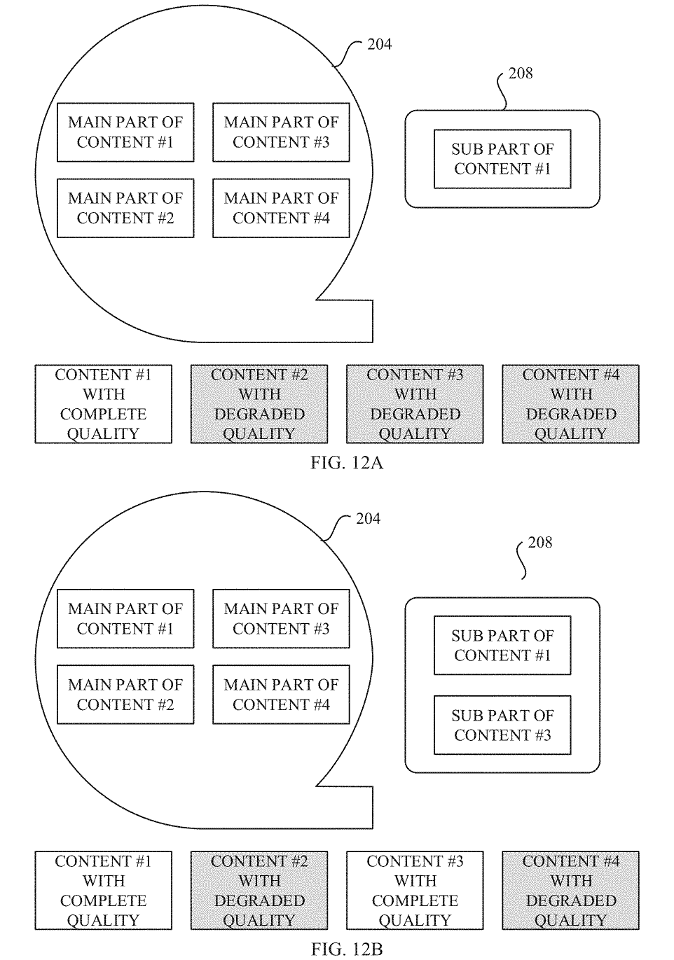

Referring to FIG. 12A, status of sharing of media content at one participant is shown, which may be a post-production company by way of example. As shown in FIG. 12A, the post-production company may perform an editing process on media content (e.g., content #1) with complete quality using the main and sub parts. At this time, the post-production company may also access and confirm the content of other media content (e.g., content #2-#4) stored on the tape medium 204 with incomplete quality.

When the post-production company wants to have other relevant media content in the course of performing the editing process to the media content (i.e., content #1), the post-production company may request additional sub parts relating to other relevant materials by checking other media content on the tape medium 204.

FIG. 12B depicts a status of sharing additional media content with complete quality. The content holding company may deliver the additional sub part of the other relevant media content (content #3) to the post-production company. As shown in FIG. 12B, the post-production company may perform the editing process on the other media content (content #3).

In the previously described embodiments, a method, associated processing device, and computer program product are disclosed for managing media content using a storage medium that is capable of permitting access to media content with incomplete quality while preventing the media content from being diverted or used for unauthorized purposes. The media content for which the relating main and sub parts are made available may be reproduced with complete quality for creating multimedia content such as ultra-high-definition television programs.

In the aforementioned embodiments, the tape medium 204 is described to store the main part. Although tape media is a promising storage media for storing huge amounts of data, embodiments of the inventions are not limited to tape media to store the main part. In other embodiments, storage media such as disk storage or solid state storage may be used to store the main part.

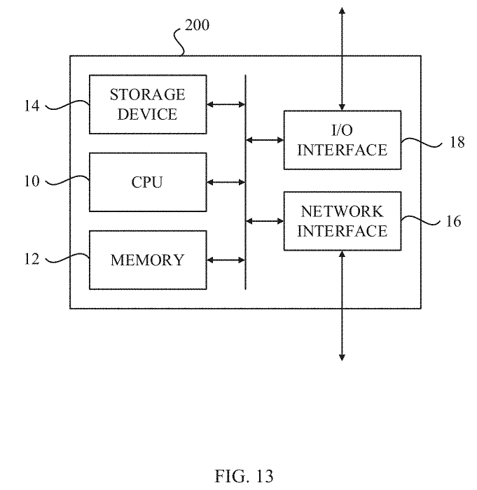

Referring now to FIG. 13, a schematic of one example of a processing device is shown. The processing device 200 is only one example of a suitable processing device and is not intended to suggest any limitation as to the scope of use or functionality of embodiments of the invention described herein. Regardless, the processing device 200 is capable of being implemented and/or performing any of the functionality set forth herein.

The processing device 200 may be operational with numerous other general purpose or special purpose computing system environments or configurations. Examples of well-known computing systems, environments, and/or configurations that may be suitable for use with the processing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The processing device 200 may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 13, the processing device 200 is shown in the form of a general-purpose computing device. The components of the processing device 200 may include, but are not limited to, one or more central processing units (CPU or processors) 10 and a memory 12 operatively coupled to the processors 10 by a bus including a memory bus or memory controller, and a processor or local bus using any of a variety of bus architectures.

The processing device 200 typically includes a variety of computer system readable media. Such media may be any available media that is accessible by the processing device 200, and it includes both volatile and non-volatile media, removable and non-removable media.

The memory 12 may include computer system readable media in the form of volatile memory, such as random access memory (RAM). The processing device 200 may further include other removable/non-removable, volatile/non-volatile computer system storage media. By way of example only, the storage device 14 may be provided for reading from and writing to a non-removable, non-volatile magnetic media. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, the storage device 14 may include at least one program product having a set (e.g., at least one) of program modules that are configured to carry out the functions of embodiments of the invention.

Programs/utilities having a set of program modules may be stored in the storage device 14 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

The processing device 200 may also communicate with one or more peripherals such as a keyboard, a pointing device, etc.; a display; one or more devices that enable a user to interact with the processing device 200; and/or any devices (e.g., network card, modem, etc.) that enable the processing device 200 to communicate with one or more other computing devices. Such communication can occur via Input/Output (I/O) interfaces 18. Still yet, the processing device 200 may communicate with one or more networks such as a local area network (LAN) 104, a general wide area network (WAN), and/or a public network (e.g., the Internet) via the network interface 16. As depicted, the network interface 16 communicates with the other components of the processing device 200 via a bus. It should be understood that although not shown, other hardware and/or software components may be used in conjunction with the processing device 200. Examples, include, but are not limited to: microcode, device drivers, redundant processing units, external disk drive arrays, RAID systems, tape drives, and data archival storage systems, etc.

The present invention may be embodied as a system, method, and/or computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more aspects of the present invention has been presented for purposes of illustration and description, but is not intended to be exhaustive or limited to the invention in the form disclosed.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for managing media content, the method comprising;
storing a first data part relating to target media content in a storage medium, the first data part being degraded media content having reduced quality compared to the target media content; and
storing a second data part relating to the target media content, the second data part being complemental data configured to be combined with the first data part to reproduce the target media content.

2. The method of claim 1, wherein storing the first data part comprises storing at least two first data parts relating to a set of at least two target media contents in the storage medium, and storing the second data part comprising storing at least one second data part relating to a subset of the set of at least two target media contents.

3. The method of claim 2, further comprising:
exporting the storage medium storing the at least two first data parts; and
outputting the at least one second data part.

4. The method of claim 3, wherein the storage medium is a tape medium and outputting comprises one of:
saving the at least one second data part into a removable medium; and
transmitting the at least one second data part through a network.

5. The method of claim 3, wherein outputting the at least one second data part comprises:
outputting at least two second data parts relating to the set of at least two target media contents.

6. The method of claim 3, wherein the target media content comprises at least one of video and audio.

7. The method of claim 1, further comprising:
receiving original data of the target media content;
generating the first data part by discarding partial information from the original data of the target media content; and
generating the second data part by organizing the partial information.

8. The method of claim 1, further comprising:
receiving original data of the target media content; and
generating the first data part and the second data part by dividing the original data.

9. The method of claim 8, wherein generating comprises:
extracting first frames from a series of frames in the original data, the first data part including the first frames, and the second data part including any remaining frames from the series of frames in the original data.

10. The method of claim 8, wherein generating comprises:
cutting a partial image from a frame of the original data, the second data part including the partial image, and the first data part including any remaining image of the frame of the original data.

11. The method of claim 1, further comprising:
reproducing the target media content with a quality higher than the first data part by reading the first data part from the storage medium and combining the second data part with the first data part.

12. A method for managing media content, the method comprising;
reading a first data part relating to target media content from a storage medium, the first data part being degraded media content having reduced quality compared to the target media content;
reading a second data part relating to the target media content, the second data part being complemental data for complementing the first data part; and
combining the second data part with the first data part to reproduce the target media content.

13. The method of claim 12, wherein combining comprises:
merging frames included in the second data part and frames included in the first data part to recover a series of original frames of the target media content.

14. The method of claim 12, wherein combining comprises:
synthesizing a partial image included in the second data part and a remaining image included in the first data part to recover an original frame of the target media content.

15. The method of claim 12, further comprising:
playing back the target media content with a quality based on the first data part, the quality being degraded compared to a full reproduction of the target media content.

16. An apparatus for managing media content, the apparatus comprising:
at least one processor;
at least one memory device operably coupled to the at least one processor and storing instructions for execution on the at least one processor, the instructions causing the at least one processor to:
store a first data part relating to target media content in a storage medium, the first data part being degraded media content having reduced quality compared to the target media content; and
store a second data part relating to the target media content, the second data part being complemental data configured to be combined with the first data part to reproduce the target media content.

17. The apparatus of claim 16, wherein the instructions further cause the at least one processor to:
receive original data of the target media content; and
generate the first data part and the second data part by dividing the original data.

18. The apparatus of claim 17, wherein the instructions further cause the at least one processor to:
extract first frames from a series of frames in the original data, the first data part including the first frames, and the second data part including any remaining frames from the series of frames in the original data.

19. The apparatus of claim 17, wherein the instructions further cause the at least one processor to:
cut a partial image from a frame of the original data, the second data part including the partial image, and the first data part including any remaining image of the frame of the original data.

20. A computer program product for managing media content, the computer program product comprising a computer readable storage medium having program instructions embodied therewith, the program instructions executable by a computer to cause the computer to perform the following:
store a first data part relating to target media content in a storage medium, the first data part being degraded media content having reduced quality compared to the target media content; and
store a second data part relating to the target media content, the second data part being complemental data configured to be combined with the first data part to reproduce the target media content.
